(19) United States
(12) Patent Application Publication
(10) Pub. No.: US 2004/0044616 A1
(43) Pub. Date: Mar. 4, 2004

(54) Loan repayment program

(75) Inventor: Maurice M. Salter, Los Angeles, CA (US)

Correspondence Address: BAKER & HOSTETLER LLP, Washington Square, Suite 1100, 1050 Connecticut Avenue, N.W., Washington, DC, 20036, US

(73) Assignee: School Loans Corporation

(21) Appl. No.: 10/364,529

(22) Filed: Feb. 12, 2003

Related U.S. Application Data
(60) Provisional application No. 60/406,967, filed on Aug. 30, 2002.

(51) Int. Cl. G06F 17/60

(52) U.S. Cl. 705/38

(57) ABSTRACT

A loan repayment program that includes steps of arranging for payments on loans of others through an organization using a centralized agency, and having the organization make payments on student loans using the centralized agency. In order to reduce payments, loans can be consolidated through the organization using the centralized agency.

### PRIORITY CLAIM

This application claims priority to provisional U.S. Patent Application entitled, Loan Assistance Program, filed Aug. 30, 2002, having serial No. 60/406,967, the disclosure of which is incorporated herein by reference.

### FIELD OF THE INVENTION

The present invention relates generally to repayment programs. More particularly, the present invention relates to loan repayment programs.

### BACKGROUND OF THE INVENTION

One important factor in running a successful business is to obtain and retain good employees. Employees play a valuable role in running the business and maintaining corporate viability. In order to retain good employees, many employers have created programs in which to keep employees from moving from job to job.

For instance, in some cases, employers offer fringe benefits such as Healthcare, Direct Deposit, and Vacation days. However as the job pool becomes more and more competitive, it becomes increasingly important for an employer to retain their best employees. Other incentives such as bonus programs, signing bonuses and company cars can be offered to employees to help retain them.

In some instances, employees will be attracted by better offers and are offered signing bonuses, moving expenses, company cars and other such fringe benefits. Many of the programs offered give employees immediate benefits to attract the employees to leave their jobs. Since these rewards are obtained on an immediate basis, this may cause good employees to jump from employer to employer, reaping many benefits in the very beginning of employment and after a year or two being attracted to move to another employer for other immediate benefits which the present employer can not offer.

Many professionals in the work force incur significant debt due to student loans. Student loans have become increasingly higher as school costs have grown substantially. In order to advance in the market place, it seems that more and more years of schooling is required thereby placing a significant burden on some professionals to obtain degrees at a significant cost to the employee.

Accordingly, it is desirable to provide a program which will attract employees to a specified employer sufficiently to offset student loan costs, however at a minimum cost to the employer, thereby keeping the employee with employer for a significant amount of time.

### SUMMARY OF THE INVENTION

The present invention provides a loan repayment program that will offset student loan payments for the employees of an employer.

In one embodiment of the invention, the loan repayment program includes steps of arranging for payments on loans of others through an organization using a centralized agency; and having the organization make payments on the loans using the centralized agency, such as School Loans Corporation.

The step of consolidating loans through the organization using the centralized agency can be used to reduce monthly payments, when an employee is eligible for consolidation.

The step of arranging for payments can include the step of arranging to make an automatic payment on the consolidated or unconsolidated loans from funds of the organization.

The step of having the organization make payments can include the step of having the organization make payments on the loans of an employee of the organization using the centralized agency.

The step of having the organization make payments can include the step of having the organization make partial payments on the loans of an employee of the organization using the centralized agency.

The invention can further include the step of consolidating loans through multiple organizations using a centralized agency.

In another embodiment, the invention can include the step of consolidating loans of employees of multiple organizations using a centralized agency.

In an alternate embodiment of the invention, a loan repayment system includes a means for arranging for payments on loans of others through an organization using a centralized agency; and a means for having the organization make payments on the-loans using the centralized agency.

A means for consolidating loans through the organization using the centralized agency can be used to reduce payments.

The means for consolidating loans can include a means for consolidating loans of an employee of the organization, a means for consolidating loans of employees of the organization, and/or a means for arranging to make an automatic payment on the consolidated loans from a paycheck of an employee of the organization.

The means for arranging for payments can include a means for arranging to make an automatic payment on the loans from funds of the organization.

The means for having the organization make payment can include a means for having the organization make payments on the loans of an employee of the organization using the centralized agency.

The means for having the organization make payment can include a means for having the organization make partial payments on the loans of an employee of the organization using the centralized agency.

The system can further include a means for consolidating loans through multiple organizations using the centralized agency and/or a means for consolidating loans of employees of multiple organizations using the centralized agency.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a block diagram showing steps of the invention.

FIG. 1B is a block diagram showing the steps of the invention for existing employees.

FIG. 1C is a block diagram showing the step of the invention for newly hired employees.

FIG. 2A is a form listing who can participate in the loan consolidation and/or repayment program.

FIG. 2B is a form that indicates whether an employer is participating in the consolidation and/or repayment program.

FIG. 2C indicates which employees are participating in the consolidation and/or repayment program.

FIG. 2D is a form which is used to identify eligible employees.

### DETAILED DESCRIPTION OF THE PREFERRED EMBODIMENTS OF THE INVENTION

The present invention provides a loan repayment program. This loan repayment program can be used as an employee retention program which will assist in offsetting student loan debt owed by an employee. For example an employer may make full or partial payments on the employee's student loans. In other cases the employer can pay off consolidated student loans or the employer can make full or partial payments on consolidated loans.

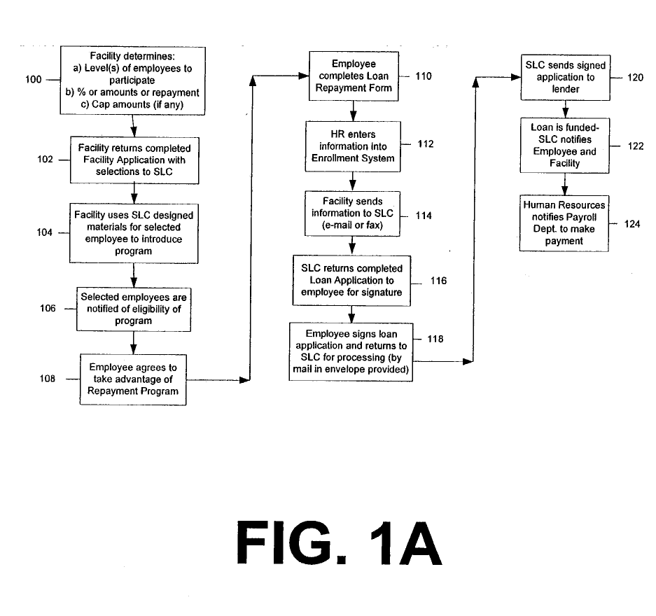

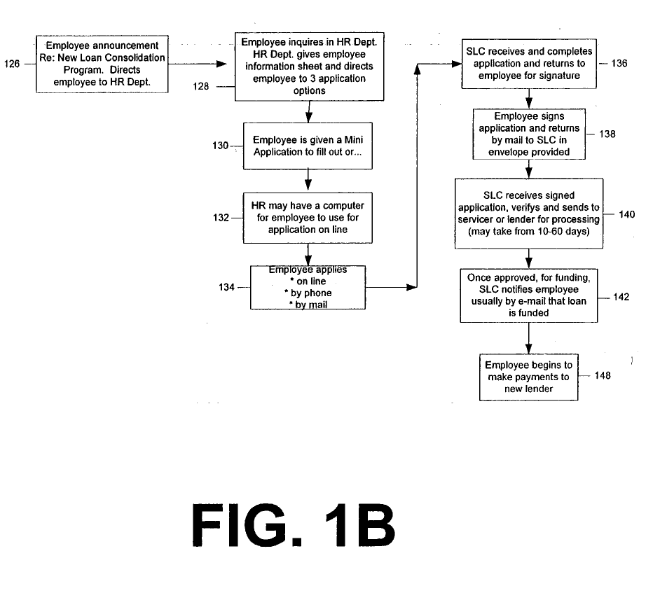

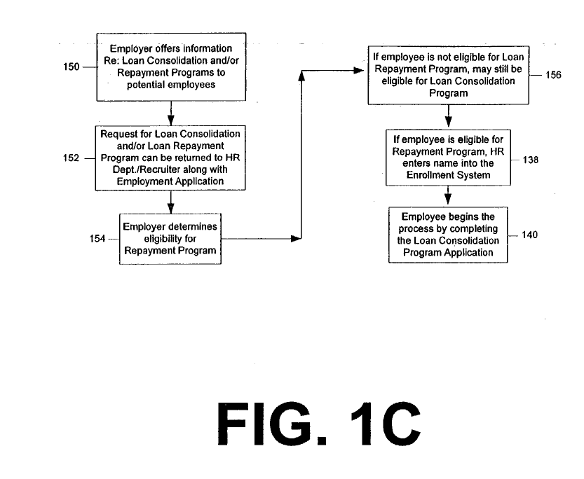

One implementation of the present invention is illustrated in FIG. 1A. In step 100 the employer or facility determines which employees are eligible to participate, the percent or amount of repayment the employer is willing to pay and a maximum amount of any the employer is willing to pay.

In step 102 the facility or employer returns a completed facility application and selections to a centralized agency such as School Loans Corporation (SLC).

In step 104 the facility uses SLC designed materials for selected employees to introduce the program to these employees. In step 106 the selected employees are notified of their eligibility in the program. In step 108 an employee can agree to take advantage of the repayment program. In step 110 if the employee agrees, the employee completes a loan repayment form.

In step 112 the Human Resources Department of the facility or employer or organization enters the information into SLC's proprietary enrollment system. The facility in step 114 then sends information to SLC. This could be through the mail, e-mail, fax or any other means of communication.

In step 116 SLC returns completed loan consolidation application to employee for signature if eligible for consolidation. In step 118 the employee signs the loan application and returns it to SLC for processing.

SLC then sends the signed application to the lender in step 120. In step 122 the loan is funded and SLC notifies employee and facility employer or organization that the loan is funded. In step 124 the Human Resources Department of the organization, facility, employer notifies the Payroll Department to make payments. The process goes from 116 to 124 in the even that the employee is not eligible for loan consolidation. These monthly payments can be made wholly by the employer. It can also be that the employer pays partial amounts of the payments and the employee pays the other part of the payment. There are many different combinations which are intended to be included.

In one embodiment of the invention one of the benefits is a payment reduction from consolidation. Employees are provided with student loan consolidation at competitive interest rates and/or other incentive plans. This can provide a fixed low interest rate and a lower monthly payment. In another embodiment of the invention, a centralized agency offers student loans other than consolidation, which the employer has the ability repay on behalf of the employee monthly.

Another advantage of the present invention is that it can also provide a loan repayment program, which reimburses employees for a portion or total amount of their monthly student loan payment for as long as they remain employees. This incentive can be made available to specific employee groups as selected by participating employers.

These benefits can be accomplished through the centralized agency (SLC) by taking advantage of the employer's size. The loan consolidation and payment reduction program leverage the employer's size to provide employees with student loan consolidation or other student loan products at industry incentives and features.

When federal loan consolidation is a part of the invention, two major benefits to the employee are a fixed low interest rate and a lower monthly payment. With federal loan consolidation, there are no application fees or credit checks.

As loan consolidation currently exists, employees can also extend the payment term up to 30 years and reduce monthly payments by up to 53% or more. These are great benefits for graduates who have large balances, need more manageable payments or simply want the flexibility and security of a longer repayment term. However, it is noted that extending the term can increase interest costs over time.

Another advantage is that employees can repay the loan early with no penalties simply by paying more than the minimum each month. It's at no additional cost and still offers the security of a longer term.

Employees can also consolidate with their spouse at any point in time—even if they have separate consolidated loans. However by consolidating, both spouses are jointly responsible for the combined amount in the event of disability, death or divorce. And in the case of deferment, both spouses need to meet the eligibility requirements.

Whether consolidating three loans or ten, employees are establishing a single convenient source of repayment simplifying finances. That means fewer checks and less paperwork. It also means that there's only one place to go to apply for deferment, forbearance or different loan terms.

After consolidating, employees have access to federal forbearance and deferments options, including education related enrollments, unemployment, economic hardship and Peace Corps. Subsidized Stafford loans retain their subsidy benefit, while Perkins and NSL loans lose their subsidy status.

Employee eligibility for all loan products can vary based on current Department of Education guidelines. In one embodiment of the invention employees are eligible for a Federal Consolidation Loan as long as they have eligible federal student loans totaling at least $7,500, are no longer a student, and are in the loan grace period or an active repayment status. A centralized organization such as School Loans Corporation can consolidate and service many types federal student loans in its Federal Consolidation Loan program such as DSS-Direct Subsidized Stafford Loans, DUS-Direct Unsubsidized Stafford Loans, DPLUS-Direct PLUS Loans, DUCON-Direct Unsubsidized Consolidation Loan, including Direct PLUS Consolidation Loans, SS-Subsidized Federal Stafford, formerly Guaranteed Student Loans (GSL), US-Unsubsidized and Nonsubsidized Federal Stafford Loans, NSL-Federal Nursing Loans, PERK-Federal Perkins Loans, formerly Nations Defense/National Direct Student Loans (NDSL), PLUS-Federal PLUS (Parent) Loans, SCON-Subsidized Federal Consolidation Loans, UCON-Unsubsidized Federal Consolidation Loans and SLS-Federal Supplemental Loans for Students (formerly Auxiliary Loans to Assist Students (ALAS) and Student PLUS Loans)

Student loans that are in default may not be eligible for inclusion. However, employees can consolidate any other loans not in default. If an employee consolidates the federal student loans that are not in default, they have 180 days to add a new loan to this consolidation.

Previously consolidated federal loans can be reconsolidated as long as there is at least one federal loan not included in the original consolidation, or as long as a spouse has a separate federal loan or federal consolidation loan, either of which they plan to now consolidate. Those ineligible to consolidate their loans could still participate through a repayment program in which the loans or a portion of the loans can be paid through payroll deductions.

By being able to repay the loan over a longer period of time, the monthly payments can be substantially reduced. However, it is important to note that the extended repayment term results in an increase in the interest costs paid over the life of the loan.

Listed below are the repayment plans available under the consolidation program:

Standard—Fixed monthly payment. The final payment may be slightly larger or smaller.

Graduated—Payments will be smaller in the beginning of repayment and gradually increase every 2 years over the course of the repayment period on the loan.

Income Sensitive—The payment amount will be adjusted annually between 4% and 25% of the employee's expected total monthly gross income. After the original lenders are repaid and the Federal Consolidation Loan is originated, employees will receive a packet of information from ACS. It will include a worksheet to help calculate the estimated monthly payment and instructions about what supporting material is required. For spousal consolidations, payments will be based on the total household income from all sources. Income sensitive payments are only in effect for 12 months at a time. Each year, income must be recertified.

Extended—For loans totaling in excess of $30,000, employees may repay over a 25-year period on a fixed or graduated payment plan. For the income sensitive plan, employees must have at least $40,000 in debt to qualify for a 25-year repayment period. Employees with debt in excess of $60,000 and wishing to repay over a 30-year period-can select the Standard, Graduated or Income Sensitive plan.

Federal student loans can have variable interest rates set by the Federal Government each July. That means when interest rates go up, payments go up. By consolidating federal student loans now, employees lock in today's low interest rate for the life of the loan. The interest rate will be the weighted average of the interest rates as of July 1 for the eligible loans being consolidated (rounded up to the nearest 1/8%), or 8.25%, whichever is less.

A centralized organization can offer two incentives to employees, friends and family who consolidate their federal student loans through this program. First, the interest rate can be reduced by 1% after making 48 consecutive, on-time payments, for the rest of the life of the loan. Second, an additional 0.25% on the interest rate can be saved by paying through automatic deduction from a bank account, for as long as you pay that way.

The following are ways in which employees can apply for consolidation or other student loan products on-line, by mail or by phone.

On-line access can be obtained through the on-line application form at several web sites, such as www.higheredloans.com by selecting “Apply On-Line”. The application can be archived and ID/Password protected.

A request can also be made through the mail. An application made by mail can be made by selecting “Apply by Mail” at many web sites, such as www.higheredloans.com and completing the contact information. Alternately, the employer's Human Resources department should have a supply of hard copy applications.

Loan specialists can also be made available by phone for consultation. The specialists can assist employees by reviewing their loan history and determining eligibility. Completed applications can be mailed to the employee for verification and signature.

No matter which method of application is selected, employees will need to return the original copy to the centralized organization.

Upon receipt of the application, the centralized organization can advise the employee that the application has been received. If the application is missing information, employees will receive an email or telephone call from a customer support representative. The centralized agency will provide periodic updates as to the status of the application.

In one embodiment of the invention, employees are offered consolidation loans. In that case, loan approval for all loans not in default can be automatic when a complete, signed application is submitted. There are no credit checks or fees. The process can take up to 30-60 days, or while the Consolidation Center contacts lenders and consolidate the loans, the servicer will notify the employee when the loan consolidation is complete.

Once the Federal Consolidation Loan is funded, all previous lenders are repaid, and employees begin making a single, lower monthly payment. Employees will receive a letter confirming that this has occurred. At any time in this process, employees can contact the centralized organization.

In the present invention the employer has very little administrative overhead for the Loan Consolidation Program. The centralized organization can provide the employer with advertising materials. The employer's Human Resources department should have materials on hand for distribution to interested employees. These materials include:

A Consolidation Loan Application Package, complete with a loan application and a return envelope (provided by School Loans Corporation)

A brochure explaining the benefits of consolidation and the advantage of employer's program (provided by School Loans Corporation)

If possible, it would be helpful if the Human Resources office has available a computer terminal to show employees where they can apply on-line.

All materials will provide information on how to contact the centralized agency with questions and assistance with the application.

Whether or not an employee consolidates, the employer will receive information on the number of employees from each facility who have consolidated their loans, taken new student loans and/or participated in the repayment program, along with other information indicating success of this incentive program.

The Loan Repayment Program is an employee retention and recruitment program. Through this Program, the employer reimburses all or part of participating employees' student loan payments on a monthly basis. Each employer will determine which employees can take advantage of this benefit. It is contemplated though, that employers will standardize their offering regionally, if not nationally.

Employees in one embodiment of the invention consolidate their federal student loans through the Federal Consolidation Program, thus reducing the monthly payment size and allowing the employer to make a single monthly payment for all participating employees.

In another embodiment of the invention, loans are not consolidated, but payments on the loans are made by the employer. For example, the employer may pay for 50% of an employees student loans directly through a payroll direction.

This invention addresses existing student loan debt in two ways. It enables graduates to consolidate their loans, thereby reducing monthly payments, extending the loan term, and locking in lower interest rates. It also creates a cost effective recruitment and retention opportunity for the employer through the repayment program.

Each employer can choose which employees or group of employees can apply for loan repayment. This can be based on employment status such as new recruited employees or existing employees.

The types of loans covered each month can be loans such as Federal Loans (Standard), Private Loans (Will Require Additional Administration and Cannot be Consolidated) or any other types of student loans or educational loans.

The amount and/or percentage covered each month can vary in percentage covered such as 100%, 75%, 50% or could simply have a cap. The employer can chooses its options upon enrollment.

The employer in some embodiments of the invention will have some administrative overhead for the loan repayment program. In areas such as marketing, the centralized organization, such as SLC can provide marketing templates to each employer for the loan repayment program. These templates can be used in recruitment materials and/or in targeted mailings to employee groups. All marketing can reference the Human Resources department as the contact to apply for eligibility to this program.

If an employee or a perspective employee is interested in the program and is eligible for consolidation, the Human Resources department can start them on the loan consolidation process. The loan consolidation process takes 30-45 days to complete, and is independent from the loan repayment program. That is, if a candidate for loan repayment consolidates and is later found ineligible for the repayment program, there is no disadvantage to having consolidated them.

A loan repayment application can be submitted along with the employment application for candidates. Alternately, it can be submitted by itself for individuals already employed by employer. In one embodiment of the invention, a technical interface can be provided to the employer's Human Resources department with a login for the technical administration system. This system will allow the HR department to enroll employees in the Loan Repayment Program, manage changes to an employee's status or repayment amount, and communicate benefit information to the payroll department. The interface will also provide reports to the employer's corporate office on number of participants and other measures of program success.

The technical interface will allow the HR department to pull the amount to reimburse employees each month. This amount will need to be provided to the Payroll department for inclusion on employee paychecks. It is up to the employer to determine how this reimbursement is indicated on the paychecks. Obviously, those no longer employed by employer will cease to receive this reimbursement automatically when paychecks stop. The employer has no obligation for the underlying loan, which remains the responsibility of the employee. In another embodiment of the invention, the employer could pay the lender directly instead of the employee.

The technical interface can also alert the employer if an employee becomes delinquent on the loan payments to the bank for loans consolidated through the centralized agency. It will be up to the employer to determine what, if anything, to do with this information.

It may be possible that employees or candidates for employment will be ineligible for consolidation, or will already have consolidated their loans. The centralized organization can provide a place in the technical interface for the HR department to indicate the loan payment each month, and will work with the employer to verify that this information is accurate. It will not be possible to confirm with absolute certainty loan repayment information in the case of private loans and/or loans not consolidated through the centralized agency.

For existing employees of an organization as shown in FIG. 1B, an employee announcement can be made to employees notifying them of the new loan consolidation program (step 126). This announcement can be put out by the Human Resources Department who can gather this information from employees. In step 128 employees will inquire in the Human Resources Department. Human Resources Department will then give the employees information sheets and will direct the employees to the two application options. In step 130 the employee is given a mini application to fill out. In step 132 HR may have a computer for the employee to submit the application on-line. Thus, the employee in step 134 will apply on-line, by phone or by mail. In step 136 the SLC will receive the completed application and return to the employee for signature. In step 138 the employee will sign the application and return it to SLC. SLC when they received the signed application in step 140 will verify and send to the servicer or lender for processing. In some cases this can take from 10-60 days. In step 142 once approved for funding SLC will notify the employee that the loan is funded. In step 144 payments will be made by the employer for the employee. As previously stated, there are a variety of ways these payments can be made.

In FIG. 1C the steps of introducing the payment programs to newly recruited employees are illustrated. In step 150 the employee offers information concerning the loan consolidation and/or loan repayment programs to potential employees. In step 152 a request for loan consolidation and/or loan repayment program can be returned to the HR Department or recruiter along with an employment application. In step 154 the employer can determine the eligibility for the loan repayment program. In step 156 if an employee is not eligible for the loan repayment program they still may be eligible for a loan consolidation program. As illustrated in step 158 if the employee is eligible for the repayment program, the HR Department enters the name into the enrollment system. In step 160 an employee begins the process by completing the loan consolidation program application. In some cases, a newly recruited employee may have a waiting period before they are eligible to participate in the loan repayment program.

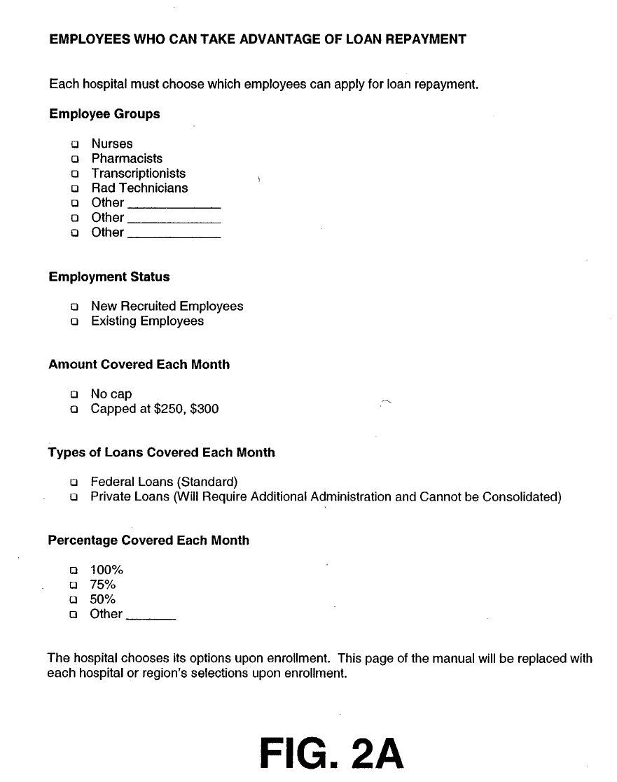

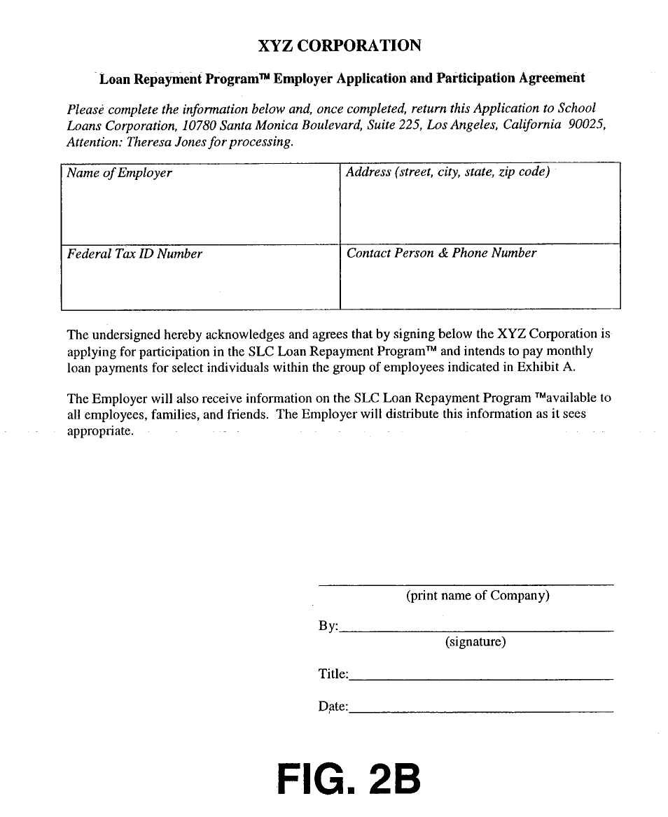

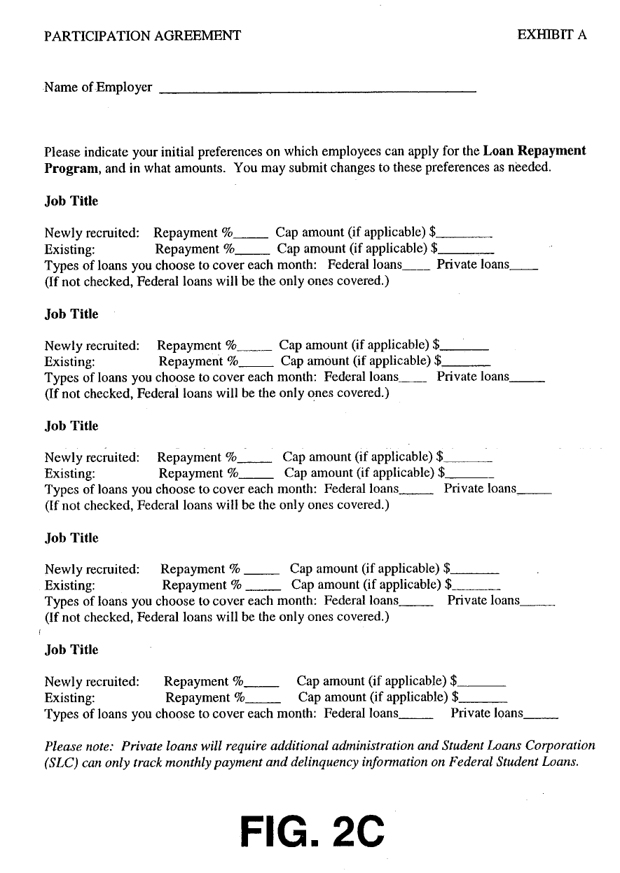

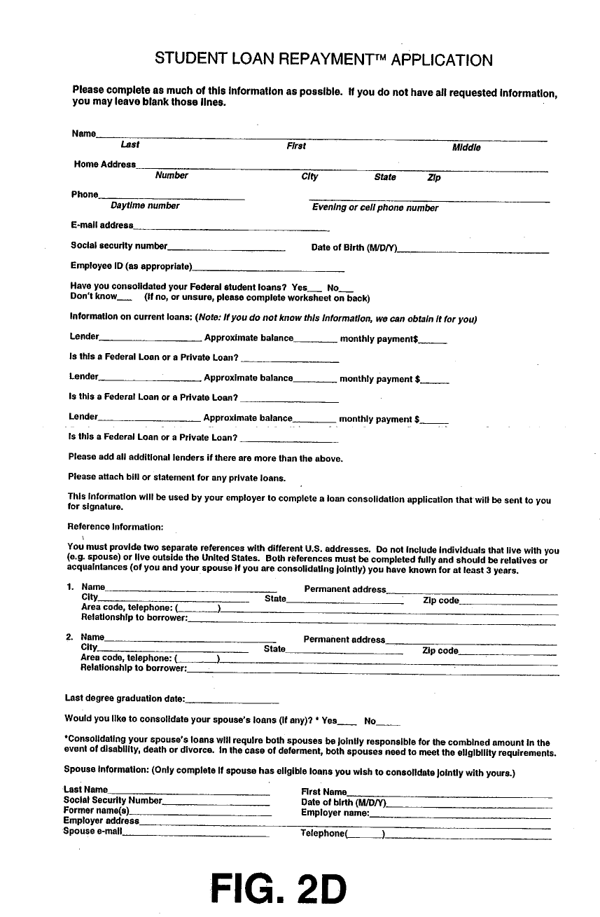

FIGS. 2A-2D illustrate some forms that can be used in initiated this repayment program. FIG. 2A illustrates employees who can take advantage of the loan repayment program. Employees can be listed and an employer can check which employees they would like to participate in the loan repayment program. The second group indicates the employment status. The third group indicates which types of loans that the employees will be eligible for and the fourth group indicates what percentage the employer will cover. For instance in some cases only existing employees will be eligible for the loan repayment program and only the second box under the section 2 employment status will be marked. However, in other cases both new recruited employees and existing employees can be included or just the newly recruited employees could be included. In the third group types of loan covered each month the employer may be able to cover only Federal Loans, only private loans or both Federal and private loans. The employer will indicate which types of loans that they can cover for each employee. In the fourth group amount and/or percentage covered each month, the employer can select how much the employer would like to cover for the employee. In some cases 100%, in other case 75%, 50% or there may be a monetary cap. For example in some cases, an employer may only cover up to $200 per month for the repayment of student loans.

To participate, the employer will fill out a form similar to the one illustrated in FIG. 2B. This will indicate who the employer is, where they are located, the Federal Tax I.D. number, and the main contact person at the corporation. This or any other type form which will indicate this type of information can be used. FIG. 2C is an Exhibit A which is referenced by the form of FIG. 2B. Exhibit A as illustrated in FIG. 2C indicates which job titles and the types of coverage you will have for each job title. This will be useful in payment of loans for different levels of employees. For instance, if someone where to have an advanced degree such as a Masters or Ph.D., the rate of the loan repayment may be higher than for someone with only an Undergraduate Degree or an Associates Degree. However, this may also be reversed in that the employer may compensate the more educated employees with higher salaries, but paying less of their loans because of the high amounts of the loans. Thus, employees with less education, may get lower salaries but higher repayment for better retention purposes of those employees.

The form illustrated in FIG. 2D is representative of an initial format a employee may fill out in order to get enough information to determine what types of loans that they have and would like to have payments made on. By filling out this form as completely as possible, a determination can be made of benefits or maximum benefits that the employer can provide to the employee.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A loan repayment program comprising the steps of:
arranging payments on loans of others by an organization using a centralized agency; and
having the organization make payments on the loans using the centralized agency.

2. The loan repayment program as recited in claim 1 further comprising the step of consolidating loans through the organization using the centralized agency.

3. The program as recited in claim 2 wherein the step of consolidating loans comprises the step of consolidating loans of an employee of the organization.

4. The program as recited in claim 2 wherein the step of consolidating loans comprises the step of consolidating loans of employees of the organization.

5. The program as recited in claim 1 wherein the step of arranging for payments comprises the step of arranging to make an automatic payment on the loans from a paycheck of an employee of the organization.

6. The program as recited in claim 1 wherein the step of arranging for payments comprises the step of arranging to make an automatic payment on the loans from funds of the organization.

7. The program as recited in-claim 1 wherein the step of having the organization make payments comprises having the organization make payments on the loans of an employee of the organization using the centralized agency.

8. The program as recited in claim 1 wherein the step of having the organization make payments comprises having the organization make partial payments on the loans of an employee of the organization using the centralized agency.

9. The program as recited in claim 1 further comprising the step of loans through multiple organizations using a centralized agency.

10. The program as recited in claim 1 further comprising the step of loans of employees of multiple organizations using a centralized agency.

11. A loan repayment system comprising:
a means for arranging for payments on loans of others through an organization using a centralized agency; and
a means for having the organization make payments on the consolidated loans using the centralized agency.

12. The system as recited in claim 11 further comprising a means for consolidating loans through the organization using the centralized agency.

13. The system as recited in claim 12 wherein the means for consolidating loans further comprises a means for consolidating loans of an employee of the organization.

14. The system as recited in claim 12 wherein the means for consolidating loans further comprises a means for consolidating loans of employees of the organization.

15. The system as recited in claim 11 wherein the means for arranging for payments comprises a means for arranging to make an automatic payment on the loans from a paycheck of an employee of the organization.

16. The system as recited in claim 11 wherein the means for arranging for payments comprises a means for arranging to make an automatic payment on the loans from funds of the organization.

17. The system as recited in claim 11 wherein the means for having the organization make payment comprises a means for having the organization make payments on the loans of an employee of the organization using the centralized agency.

18. The system as recited in claim 11 wherein the means for having the organization make payment comprises a means for having the organization make partial payments on the loans of an employee of the organization using the centralized agency.

19. The system as recited in claim 11 further comprising a means for consolidating loans through multiple organizations using the centralized agency.

20. The system as recited in claim 11 further comprising a means for consolidating loans of employees of multiple organizations using the centralized agency.
